(19) United States
(12) Patent Application Publication
(10) Pub. No.: US 2004/0043787 A1
(43) Pub. Date: Mar. 4, 2004

(54) Method and communication system for controlling the user interface of a mobile communication terminal

(76) Inventors: Michael Helbing, Munchen (DE); Klaus Wille, Munchen (DE); Rainer Windecker, Kreuzlingen (CH)

Correspondence Address: STAAS & HALSEY LLP, SUITE 700, 1201 NEW YORK AVENUE, N.W., WASHINGTON, DC, 20005, US

(21) Appl. No.: 10/467,373

(22) PCT Filed: Jan. 22, 2002
(86) PCT No.: PCT/DE02/00197

(30) Foreign Application Priority Data
Feb. 7, 2001 (DE) 101 05 583.8

(51) Int. Cl. H04M 1/00

(52) U.S. Cl. 455/554.1; 455/435.1; 455/555

(57) ABSTRACT

The invention relates to a method and a communication system for controlling the user interface of a mobile communication terminal (MKE), which is registered to a communication facility (PBX). Said communication facility uses a stimulus telephone protocol (STP) for controlling a user interface of wire-linked communication terminals (DEG). According to the invention, control information for the representation of the user interface in the mobile communication terminal (MKE) is transmitted by the communication facility (PBX) to the mobile communication terminal (MKE) at least partially by means of a packet-oriented communication protocol (WAP) converted from the stimulus telephone protocol (STP).

Communication facilities employed in enterprises and the wire-linked communication terminals (simplified below to “terminals”) associated with these facilities generally offer a wider range of features than those available in public telephone networks, such as the features “callback on busy” and “call pickup”. The processes of operating and setting these features are often supported by a display unit on the terminal which, among other things, displays possible actions or setting options.

An intuitive form of input (such as defining speed-dialing keys, setting a forwarding destinations etc.) is facilitated by, for instance, a menu-prompted navigation system by means of two arrow keys and a confirmation key, with users being able to employ the arrow keys to select an option or submenu entry, assisted by the explanations shown on the display unit, and to initiate the selected action by pressing the confirmation key. This form of input also allows inexperienced users to familiarize themselves quickly with the terminal's operation.

In the case of modern communication facilities, such as Siemens' HICOM series, the contents of a terminal's display unit, consisting of textual information, is defined exclusively by the communication facility and transmitted to the terminal in the form of control information, over the D-channel of an ISDN line for example. In the opposite direction, control information is transmitted to the communication facility when a key on the terminal has been actuated. This control information only characterizes the actuated key; its meaning is only assigned in the communication facility as a function of settings made by the user registered to this terminal. An example of this is the speed-dialing key, the actuation of which causes control information identifying the key—information also referred to below as a key stimulus—to be transmitted from the terminal to the communication facility. The communication facility uses the received key stimulus to assign the key function (speed dialing) and key contents (the directory number stored by the user on this speed-dialing key) in a manner dependent on data stored on a user-specific basis. The protocol for the bi-directional exchange of this type of control information between the communication facility and terminal—generally referred to as stimulus telephone protocol—thus supports the relocation of computing power to the communication facility to the maximum extent possible.

The term ‘user interface’ refers below to the presentation of information (with the aid, for example, of a display unit, acoustic signals, signal lamps etc.) to a user's terminal and, in the wider sense, refers also to the terminal's operating conventions (employing menu-prompted selection, for example).

In view of the increasingly widespread use of mobile terminals, many enterprises now wish to additionally equip their existing communication facility for employing these mobile terminals. The aim is for an owner of a mobile terminal to be registered as a user of the telephone network administered by the communication facility and, furthermore, to have access to the same range of features and operating options as a user registered to this communication facility via a wire-linked terminal.

Linking GSM (Global System for Mobile Communications) systems to corporate communication facilities permits, in terms of feature scope, the partial integration of users with a mobile terminal into a corporate telephone network, with the GSM systems employed in in-house communication networks customarily being referred to as CGSM systems (Corporate GSM).

Because, as mentioned at the start, the features available in a communication facility are usually more extensive than those offered in public telephone networks, in particular also in the case of (C)GSM systems, the problem arises of being able to operate and set these features also on mobile terminals. For ease of operation, the user interface which a user sees on a mobile terminal should be largely identical to that on a wire-linked terminal. Although many displays on a mobile terminal are controlled indirectly by the GSM station to which the mobile terminal is registered (the display of the telecommunications service provider, for example), the contents of the graphical display unit are defined exclusively by the mobile terminal's control electronics.

The present invention relates to a method and a communication system by means of which commercially available mobile terminals can be connected employing an existing communication facility.

The object of the invention is achieved by means of the features of claim 1 or 8.

With the method according to the invention, control information for emulating a user interface of a wire-linked terminal is transmitted to a mobile terminal at least partially by means of a packet-oriented communication protocol, in particular the WAP (Wireless Application Protocol) protocol. This control information can be transmitted exclusively by means of the WAP protocol or simultaneously by means of the WAP protocol and what is termed the GSM (Global System for Mobile Communications) protocol. Virtually all new mobile terminals contain a visualizing unit—frequently referred to in the relevant literature as a browser—with which it is possible to access data transmission systems where data is exchanged in accordance with the WAP protocol. This browser is able to receive the control information for the user interface and convert it to a graphical representation on a display unit on the mobile terminal. Although users normally operate a mobile terminal's browser and telephony function employing exclusively one of the cited functions, there are no technical obstacles to a simultaneous exchange of voice and control information in accordance with the GSM protocol and data packets in accordance with the WAP protocol.

A major advantage of the method according to the invention is that in order to represent the user interface it is possible to employ commercially available mobile terminals that only have to have a browser for packet-oriented data protocols. This obviates the expensive step of modifying the device electronics or the control software of the mobile terminal.

A further advantage of the method according to the invention is that the use of a standardized, packet-oriented data interface (WAP, for example) makes the characteristics of the control information for representing the user interface independent of the mobile terminal's technical design.

Advantageous further embodiments of the invention are described in the subclaims.

The design of the user interface is advantageously analogous to that of a wire-linked terminal connected to the same communication facility so as to ensure users familiar operation. An embodiment of the invention is explained below in greater detail with the aid of the drawing.

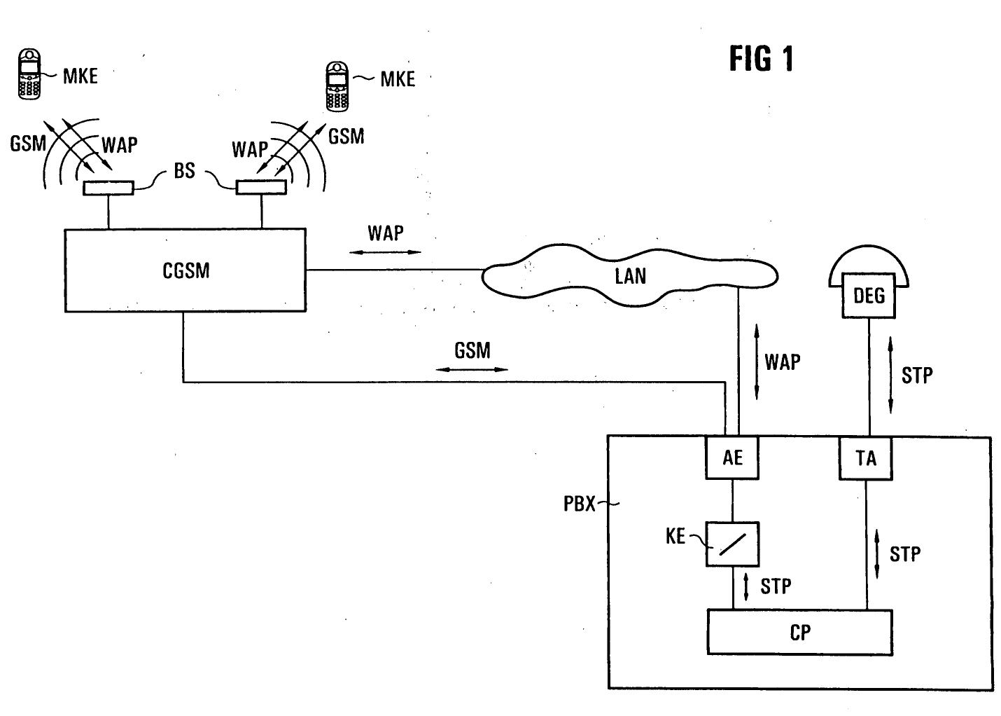

FIG. 1: shows a structure diagram schematically representing a communication system with mobile terminals; and

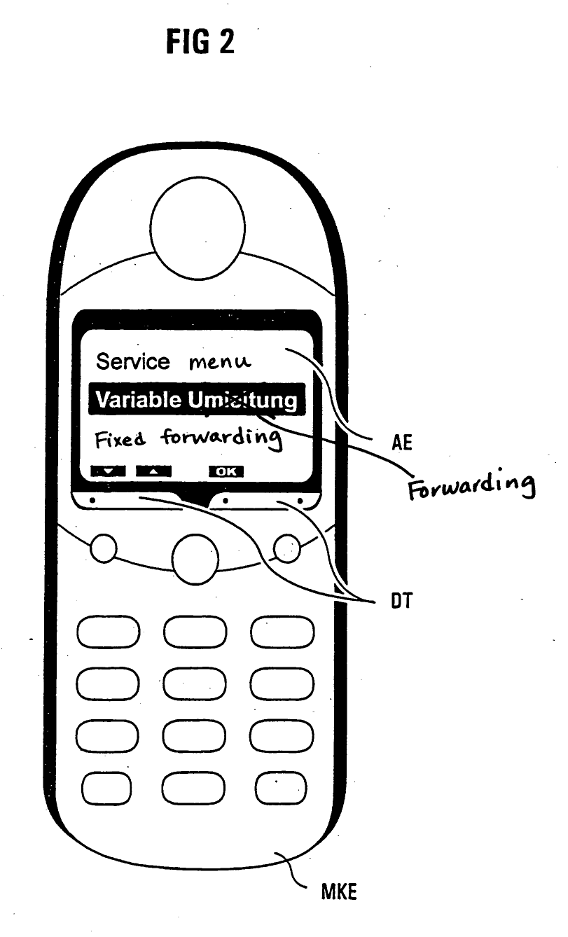

FIG. 2: a schematic representation of a mobile terminal.

FIG. 1 shows a communication facility PBX that has a conversion unit KE connected to a call-processing and feature control unit CP. The conversion unit KE is connected in its turn to a line unit AE. The conversion unit KE can alternatively also be designed as an autonomous unit externally connected to the communication facility PBX.

The call-processing and feature control unit GP controls, among other things, the user interface of a wire-linked terminal DEG connected to a subscriber line unit TA of the communication facility PBX. Using what is termed a stimulus telephone protocol STP, on the one hand key stimuli and other stimuli such as “handset lifted” or “handset replaced” are sent from the wire-linked terminal DEG to the communication facility PBX via the subscriber line unit TA and, on the other hand, display elements for the user interface of the wire-linked terminal DEG are controlled by transmitting appropriate control information.

The call-processing and feature control unit CP additionally controls the user interface of a mobile terminal via the conversion unit KE. To control the user interface of the mobile terminal MKE registered to the communication facility PBX, the conversion unit KE converts the stimulus telephone protocol STP to a WAP packet-oriented communication protocol—by means of which it communicates with the line unit AE—and vice versa.

The line unit AE is on the one hand connected to a data network LAN, with the line unit exchanging data with a CGSM system CGSM on the basis of the WAP packet-oriented communication protocol; on the other hand the line unit AE is connected to the CGSM system CGSM via a line GSM that transmits data and voice information in accordance with the GSM protocol and via which transmission of both voice information and control information is effected.

The term ‘LAN’ (Local Area Network) refers in the embodiment to a local area data network, but one which in topological scale is not subject to any local limitations and so can also be designed as a WAN (Wide Area Network).

It is assumed in this embodiment that the information for controlling the user interface of a mobile terminal MKE registered to the communication facility PBX is transmitted exclusively using the WAP packet-oriented communication protocol. However, it is also possible to implement other embodiments of the invention in which the control information is only partially exchanged using the WAP packet-oriented communication protocol, with other information—necessary for controlling the user interface—continuing to be transmitted using the GSM protocol. Examples of this would be signaling information which, among other things, reports the user's lifting or replacing of the handset, and the transmission of digits when a user directory number is dialed.

Base stations BS are connected to the CGSM system CGSM which via an air interface (shown in the drawing as concentric arcs) communicate data on the basis of the WAP packet-oriented communication protocol and of the GSM standard GSM with two mobile terminals MKE.

To control a display unit of a mobile terminal MKE, the conversion unit KE converts control information received from the control unit to the WAP packet-oriented communication protocol and sends this control information via the data network LAN to the CGSM system CGSM, where it is transmitted to a mobile terminal MKE by a base station BS via the air interface. In the opposite direction, key stimuli transmitted by the conversion unit KE in accordance with the WAP packet-oriented communication protocol are converted to the stimulus telephone protocol STP of a wire-linked terminal DEG and transmitted to the call-processing and feature control unit CP.

A function corresponding to the key stimulus is initiated in the communication facility PBX by the call-processing and feature control unit CP.

FIG. 2 shows a mobile terminal MKE with a display unit AE and two display keys DT assigned to this display unit. The two display keys DT are each designed as a rocker key so that two different actions can be initiated by the operator of the mobile terminal MKE by means of one display key DT, depending on whether it is actuated in the left-hand or right-hand subarea of the relevant display key DT.

In the case of a mobile terminal's user interface, each display key DT is usually assigned operating options that are shown in the display unit AE immediately above the keys. In the present example these are two arrows and a confirmation (“OK”).

The display unit AE and the display keys DT emulate a terminal's user interface where settings can be made with the aid of arrow keys and a confirmation key. With the display keys DT assigned to the two arrows it is possible to navigate within various submenus or setting options that are selected using the display key DT assigned to the “OK” operating option.

In the present embodiment users can select the “Variable forwarding” submenu using the “OK” operating option and skip to the “Service menu” or “Fixed forwarding” submenus using the “Up arrow” or “Down arrow” operating options.

1. Method for controlling a user interface of a mobile communication terminal (MKE) registered to a communication facility (PBX) with which control information for representing the user interface is transmitted from the communication facility (PBX) to the mobile communication terminal (MKE) at least partially by means of a packet-oriented communication protocol (WAP).

2. Method according to claim 1
characterized in that
the control information is exchanged between the mobile communication terminal (MKE) and communication facility (PBX) using the WAP protocol known per se.

3. Method according to one of the preceding claims
characterized in that
the user interface facilitates menu control by means of direction-selection and confirmation keys.

4. Method according to one of the preceding claims
characterized in that
the user interface of the mobile communication terminal (MKE) is emulated analogously to a user interface of a wire-linked communication terminal connected to the communication facility (PBX).

5. Method according to claim 4
characterized in that
the wire-linked communication terminals of the communication facility (PBX) are controlled by a system-specific stimulus telephone protocol (STP).

6. Method according to claim 5
characterized in that
the actuation of a key on the mobile communication terminal (MKE) causes control information to be transmitted to the communication facility (PBX) by means of the packet-oriented communication protocol (WAP),
and in that this control information is converted by the communication facility (PBX) to the system-specific stimulus telephone protocol (STP).

7. Method according to one of the claims 5 or 6
characterized in that
a bi-directional conversion is performed between the system-specific stimulus telephone protocol (STP) and packet-oriented communication protocol (WAP) by a conversion unit (KE) assigned to the communication facility (PBX).

8. Communication system for controlling a user interface of a mobile communication terminal (MKE) with a communication facility (PBX) for connecting wire-linked communication terminals, where the user interface of these communication terminals is controlled by a system-specific stimulus telephone protocol (STP), with a conversion unit (KE) assigned to the communication facility (PBX) for the bi-directional conversion of control information of the system-specific stimulus telephone protocol (STP) and a packet-oriented communication protocol (WAP), and with one or more cellular base stations (BS) for transmitting the converted control information to the mobile communication terminal (MKE).

9. Communication system according to claim 8
characterized in that
the cellular base station (BS) is part of a GSM and/or CGSM system (CGSM).

10. Communication system according to one of the claims 8 or 9
characterized in that
the conversion unit is connected to the GSM or CGSM system (CGSM) via a local area network (LAN).

11. Communication system according to one of the claims 8 to 10
characterized in that
the conversion unit (KE) is integrated in the communication facility (PBX).
